(19) United States
(12) Patent Application Publication
(10) Pub. No.: US 2010/0026133 A1
(43) Pub. Date: Feb. 4, 2010

(54) COIL PRODUCTION METHOD, COIL OF MOTOR, AND STATOR OF MOTOR

(76) Inventors: Shingo Fubuki, Toyota-shi (JP); Kenji Harada, Nishikamo-gun (JP)

Correspondence Address: KENYON & KENYON LLP, 1500 K STREET N.W., SUITE 700, WASHINGTON, DC, 20005, US

(21) Appl. No.: 12/520,712

(22) PCT Filed: Jan. 9, 2008
(86) PCT No.: PCT/JP2008/050475

§ 371 Date: Jun. 22, 2009

(30) Foreign Application Priority Data
Jan. 17, 2007 (JP) 2007-008376

(51) Int. Cl. H02K 3/04; H02K 15/085

(52) U.S. Cl. 310/208; 29/596

(57) ABSTRACT

A coil production method capable of improving the space factor of a rectangular conductor with respect to the slot of a stator core, a coil of a motor, and a stator of a motor. The coil production method in which one surface of a rectangular conductor is brought into contact with a shaft with guide, and edgewise bending is performed along the curved surface of the shaft, wherein a deforming mechanism for reducing the plate thickness of a plate thickness changed portion corresponding to each of four corners of a coil over the entire width of the rectangular conductor is provided, the deformation mechanism is used to deform the plate thickness changing portion, and the plate thickness changing portion of the rectangular conductor is edgewise-bent to form a coil.

### CROSS-REFERENCE TO RELATED APPLICATIONS

This is a national phase application filed under 35 U.S.C 371 of PCT/JP2008/050475 filed on Jan. 9, 2008, which claims the benefit of priority from the prior Japanese Patent Application No. 2007-008376 filed on Jan. 17, 2007, the entire contents of all of which are incorporated herein by reference.

### FIELD OF THE INVENTION

The present invention relates to a stator of motor using a coil produced by edgewise bending a rectangular conductor into a spirally wound form, a coil of motor, and a coil production method.

### BACKGROUND OF THE INVENTION

A stator to be used in a motor is generally a wire-wound stator. In recent years, however, downsized and high-power motors have been demanded. Thus, there is proposed a method of producing a coil by edgewise bending a rectangular conductor to be used in the stator.

The stator using the coil produced by edgewise bending the rectangular conductor is unsuitable for lap-winding but has a better heat release property to flow a larger quantity of current as compared with the wire-wound stator in which a circular cross-section conductor is wound. Furthermore, a space factor can be increased, thereby enhancing the motor efficiency.

Such a method of producing a coil by edgewise bending a rectangular conductor is disclosed in Patent Literature 1.

FIG. 20 is a schematic perspective view of a winding apparatus of Patent Literature 1.

The winding apparatus and an electric motor of Patent Literature 1 are configured to wind a rectangular conductor 160 around a salient pole 152 having an almost rectangular cross-section provided in a split stator core part by a winding apparatus including a mounting jig 132 on which the core part 150 is mounted, a core rotating motor 134 serving as a power supply, and a transmission unit 136 for transmitting driving power of the motor 134 to the mounting jig 132 side.

This electric motor includes load rollers 111 arranged to move vertically in sync with rotation of the motor 134 to thereby squeeze one edge portion of the rectangular conductor 160.

A problem likely to occur when the rectangular conductor 160 is edgewise bent is that an inner-peripheral portion of the rectangular conductor 160 is bulged due to the edgewise bending.

This bulge is caused by a difference in length between the outer periphery and the inner periphery of the rectangular conductor 160 and bulged portions will interfere with each other when the rectangular conductor 160 is laminated to form a coil. This would decrease the space factor when the coil is mounted in a slot of the stator core part.

In Patent Literature 1, therefore, the load rollers 111 are placed before the winding mechanism to squeeze a portion of the rectangular conductor 160 corresponding to the inner peripheral side which tends to bulge during edgewise bending. The squeezed portion is then bulged during edgewise bending and hence the bulging is balanced out. Thus, the thickness of the rectangular conductor 160 does not become larger than the thickness thereof before winding.

### SUMMARY OF INVENTION

### Technical Problem

However, in the conventional technique disclosed in Patent Literature 1, only the inner peripheral portion is squeezed, which conceivably causes a problem that interferes with edgewise bending.

In Patent Literature 1, a portion corresponding to the inner peripheral side of a coil is squeezed by the load rollers 111 before edgewise bending. However, when one edge portion of the rectangular conductor 160 is squeezed in such a way, the material of the squeezed portion is spread outward. This may cause the rectangular conductor 160 to warp on an unsqueezed side.

This warping direction is opposite to the bending direction of edgewise bending. This is therefore conceived as an interference with bending during edgewise bending and will cause winding disturbance in coil winding. As a result, the coil may become undulant or tilt during winding, leading to a defect.

When the winding disturbance occurs during coil winding, the rectangular conductor could not be laminated in good arrangement and hence could not contribute improvement of the space factor with respect to a slot of a stator core.

In Patent Literature 1, one example of the conventional technique, as above, only the inner peripheral portion is squeezed and thus a problem occurs that interferes with edgewise winding. Due to such problem, it may be difficult to increase the space factor with respect to a slot of a stator core even by edgewise bending of the rectangular conductor.

The present invention has been made to solve the above problems and has a purpose to provide a motor coil production method, a coil of motor, and a stator of motor, capable of improving the space factor of a rectangular conductor with respect to a slot of a stator core.

### Solution to Problem

To achieve the above purpose, the motor coil production method according to the present invention has the following features.

(1) There is provided a coil production method for forming a coil of motor in a spirally wound form by edgewise bending a rectangular conductor having a rectangular cross-section along a curved surface of a bending jig in a direction of a short side of the rectangular cross-section while one surface of the rectangular conductor is placed in contact with a bending jig, wherein the method includes deforming means for deforming the rectangular conductor over the entire width thereof so that the thickness corresponding to a length of the short side of the rectangular cross-section of the rectangular conductor is reduced to form a thickness changed portion corresponding to each of four corners of the coil constituted of the edgewise bent rectangular conductor, the method comprises: forming the thickness changed portion of the rectangular conductor by the deforming means; and edgewise bending the thickness changed portion of the rectangular conductor to form the coil.
(2) There is provided a coil production method for forming a coil of a motor in a spirally wound form by edgewise bending a rectangular conductor having a rectangular cross-section along a curved surface of a bending jig in a direction of a short side of the rectangular cross-section while one surface of the rectangular conductor is placed in contact with a bending jig, wherein the method includes deforming means for deforming the rectangular conductor over the entire width thereof so that the thickness corresponding to a length of the short side of the rectangular cross-section of the rectangular conductor is reduced to form a thickness changed portion corresponding to each of four corners of the coil constituted of the edgewise bent rectangular conductor, the method comprises: reducing the thickness so that both edge portions of the thickness changed portion are symmetric with respect to a center line passing the center of a long side of the rectangular cross-section of the rectangular conductor; and edgewise bending the thickness changed portion of the rectangular conductor to form the coil.
(3) In the coil production method described in (1) or (2), the deforming means deforms the rectangular conductor to reduce the thickness by a thickness increasing amount of the thickness on an inner peripheral side of the coil estimated to increase when the rectangular conductor is edgewise bent, so that after edgewise bending of the rectangular conductor, a portion of the thickness changed portion on the inner peripheral side of the coil becomes equal to the original thickness of the rectangular conductor not yet deformed by the deforming means.
(4) In the coil production method described in one of (1) to (3), the deforming means presses the thickness changed portion by sandwiching the rectangular conductor from above and below by pressing means symmetrically placed above and below the rectangular conductor to reduce the thickness of the rectangular conductor.
(5) In the coil production method described in one of (1) to (4), the method includes: bending means rotatable about a central axis of a curved surface of the bending jig to edgewise bend the rectangular conductor; and feeding means for feeding the rectangular conductor at a predetermined distance relative to the bending jig to determine a position of the rectangular conductor to be edgewise bent, and the method comprises: forming the thickness changed portion of the rectangular conductor by the deforming means; feeding the rectangular conductor at the predetermined distance by the feeing means, and edgewise bending the thickness changed portion of the rectangular conductor while placing the rectangular conductor in contact with the curved surface of the bending jig by the bending means.
(6) In the coil production method described in one of (1) to (5), the method includes tilt-preventing means for preventing the rectangular conductor from tilting in an axial direction of the curved surface of the bending jig during edgewise bending, and the method comprises edgewise bending the rectangular conductor while pressing the long side of the rectangular cross-section of the rectangular conductor by the tilt-preventing means.
(7) In the coil production method described in (6), the tilt-preventing means is provided on one side of the curved surface of the bending jig, the bending jig includes a mechanism for pressing in the axial direction to be also used as the deforming means, the method comprises edgewise bending the rectangular conductor by the bending means and then pressing the thickness changed portion of the rectangular conductor by the tilt-preventing means to correct a bulging portion of the rectangular conductor generated during the edgewise bending.

Furthermore, to achieve the above purpose, the coil of motor according to the invention has the following features.

(8) There is provided a coil of motor formed in a spirally wound shape by edgewise bending the rectangular conductor having a rectangular cross-section in a direction of a short side of a rectangular cross-section of the rectangular conductor, wherein the rectangular conductor is deformed over the entire width thereof so that the thickness corresponding to a length of the short side of the rectangular cross-section is reduced to form a thickness changed portion corresponding to each of four corners of the coil, and the thickness changed portion of the rectangular conductor is edgewise bent and the thickness of a bent portion on the inner peripheral side is increased to become equal to the thickness of another portion of the rectangular conductor.
(9) In the coil of motor described in (8), both edge portions of the thickness changed portion are deformed symmetrically so that respective thicknesses are reduced.
(10) A stator of motor is produced using the coil of motor described in (8) or (9).

### Advantageous Effects of Invention

The motor coil production method according to the invention having the above features can provide the following operations and effects.

Firstly, in the invention described in (1), in a coil production method for forming a coil of a motor in a spirally wound form by edgewise bending a rectangular conductor having a rectangular cross-section along a curved surface of a bending jig in a direction of a short side of the rectangular cross-section while one surface of the rectangular conductor is placed in contact with a bending jig, the method includes the deforming means for deforming the rectangular conductor uniformly over the entire width thereof so that the thickness corresponding to a length of the short side of the rectangular cross-section of the rectangular conductor is reduced to form a thickness changed portion corresponding to each of four corners of the coil constituted of the edgewise bent rectangular conductor. The deforming means forms the thickness changed portion of the rectangular conductor. The thickness changed portion of the rectangular conductor is edgewise bent to form the coil. Accordingly, the thickness changed portion is reduced in thickness over the entire width of the rectangular conductor instead of that only the inner peripheral side of the coil of the rectangular conductor is uniformly reduced in thickness before the edgewise bending as disclosed in Patent Literature 1. Thus, the material is uniformly spread forward and backward. The rectangular conductor therefore will not warp in a direction opposite to an edgewise bending direction, different from the case where only the inner peripheral side of the coil is decreased in thickness. This can produce the coil capable of achieving a high space factor when inserted in a slot of a stator core.

Furthermore, the thickness changed portion is formed by reducing the thickness uniformly over the entire width of the rectangular conductor and then the thickness changed portion is edgewise bent. This causes the inner peripheral side of the coil to bulge. A bulging amount by the edgewise bending is constant as long as the same bending is conducted. Accordingly, when the thickness of the rectangular conductor is uniformly reduced in advance so as to return to the original size when the rectangular conductor bulges, the thickness of the rectangular conductor returns to the original thickness after the edgewise bending. Consequently, unnecessary resistance portion is unlikely to be formed.

If the thickness of the rectangular conductor is decreased over the entire width thereof, the thickness on the outer peripheral side remains thin after the edgewise bending. The electric current tends to flow in a place that allows the current to easily flow and, after the edgewise bending, and the current density of the inner peripheral side is high and the current density of outer peripheral side is low. Thus, almost no influence is caused.

When the thickness of the inner peripheral side of the edgewise bent rectangular conductor is simply decreased as in Patent Literature 1, unnecessary warp in the opposite direction may occur. The thickness is reduced over the entire area and therefore the warp in the opposite direction is unlikely to occur.

Consequently, the coil production method capable of producing the coil of motor with an enhanced space factor of the rectangular conductor with respect to the slot of the stator core can be provided.

In the invention described in (2), in [[the]] a coil production method-for forming a coil of a motor in a spirally wound form by edgewise bending a rectangular conductor having a rectangular cross-section along a curved surface of a bending jig in a direction of a short side of the rectangular cross-section while one surface of the rectangular conductor is placed in contact with a bending jig, the method includes deforming means for deforming the rectangular conductor over the entire width thereof so that the thickness corresponding to a length of the short side of the rectangular cross-section of the rectangular conductor is reduced to form a thickness changed portion corresponding to each of four corners of the coil constituted of the edgewise bent rectangular conductor, the method comprises: reducing the thickness so that both edge portions of the thickness changed portion are symmetric with respect to a center line passing the center of a long side of the rectangular cross-section of the rectangular conductor; and edgewise bending the thickness changed portion of the rectangular conductor to form the coil. Accordingly, a decrease in the cross-sectional area of the thickness changed portion can be minimized. When the thickness is reduced so that both edge portions, not the entire portion, are symmetric in shape, the center portion of the rectangular conductor will not be squeezed. Since the center portion of the rectangular conductor is not so squeezed than in (1) in which the thickness is reduced uniformly over the entire width, the coil production method can be provided to produce the coil capable of enhancing the space factor with respect to the slot of the stator core.

In the invention described in (3), in the coil production method described in (1) or (2), the deforming means deforms the rectangular conductor to reduce the thickness by a thickness increasing amount of the thickness on an inner peripheral side of the coil estimated to increase when the rectangular conductor is edgewise bent, so that after edgewise bending of the rectangular conductur, a portion of the thickness changed portion on the inner peripheral side of the coil becomes equal to the original thickness of the rectangular conductor not yet deformed by the deforming means. Accordingly, the coil can be produced with the constant thickness on the inner peripheral side even when the rectangular conductor is edgewise bent.

As mentioned above, the current density of the outer peripheral side of the coil is low. Thus, almost no influence is caused by thinned thickness. Consequently, the coil production method can be provided capable of producing the coil having a high space factor and providing substantially uniform resistance.

In the invention described in (4), in the coil production method described in one of (1) to (3), the deforming means presses the thickness changed portion by sandwiching the rectangular conductor from above and below by pressing means symmetrically placed above and below the rectangular conductor to reduce the thickness of the rectangular conductor. Accordingly, the thickness of the thickness changed portion can be uniformly reduced.

In the invention described in (5), in the coil production method described in one of (1) to (4), the method includes: bending means rotatable about a central axis of a curved surface of the bending jig to edgewise bend the rectangular conductor; and feeding means for feeding the rectangular conductor at a predetermined distance relative to the bending jig to determine a position of the rectangular conductor to be edgewise bent, and the method comprises: forming the thickness changed portion of the rectangular conductor by the deforming means; feeding the rectangular conductor at the predetermined distance by the feeing means, and edgewise bending the thickness changed portion of the rectangular conductor while placing the rectangular conductor in contact with the curved surface of the bending jig by the bending means. Accordingly, the steps of feeding at the predetermined distance by the feeding means and bending by the bending means are repeated to edgewise bend the rectangular conductor to form the coil. Thus, the position to be bent by the bending jig and the position to be deformed by the deforming means will not be relatively displaced, so that the rectangular conductor can be deformed by a required amount at an intended position.

In the invention described in (6), in the coil production method described in one of (1) to (5), the method includes tilt-preventing means for preventing the rectangular conductor from tilting in an axial direction of the curved surface of the bending jig during edgewise bending, and the method comprises edgewise bending the rectangular conductor while pressing the long side of the rectangular cross-section of the rectangular conductor by the tilt-preventing means. Accordingly, the rectangular conductor can be guided and edgewise bent even if a force is exerted on the rectangular conductor to tilt during edgewise bending.

In the invention described in (7), in the coil production method described in (6), the tilt-preventing means is provided on one side of the curved surface of the bending jig, the bending jig includes a mechanism for pressing in the axial direction to be also used as the deforming means, the method comprises edgewise bending the rectangular conductor by the bending means and then pressing the thickness changed portion of the rectangular conductor by the tilt-preventing means to correct a bulging portion of the rectangular conductor generated during the edgewise bending. Accordingly, the bending jig is also used as the deforming means and hence the deforming means does not need to be provided in a separate process, so that a facility can be simplified.

The tilt-preventing means of the bending jig is provided on one side of the curved surface of the bending jig to prevent the rectangular conductor from tilting during edgewise bending of the rectangular conductor. Thus, the curved surface of the rectangular conductor and the tilt-preventing means are in contact relation. When the bending jig is moved from this position in the axial direction of the curved surface of the bending jig to press the rectangular conductor, thereby correcting the bulging of the rectangular conductor.

As above, the coil can be produced by correcting the bulging on the inner peripheral side of the rectangular conductor occurring during edgewise bending of the rectangular conductor. Accordingly, when the coil is mounted in the slot of the stator core, the space factor can be enhanced.

Furthermore, the coil of motor according to the invention having the above features can provide the following operations and effects.

The invention described in (8), the rectangular conductor is deformed over the entire width thereof so that the thickness corresponding to a length of the short side of the rectangular cross-section is reduced to form a thickness changed portion corresponding to each of four corners of the coil, and the thickness changed portion of the rectangular conductor is edgewise bent and the thickness of a bent portion on the inner peripheral side is increased to become equal to the thickness of another portion of the rectangular conductor. Accordingly, the coil capable of increasing the space factor of the stator core part when mounted in a slot.

In the invention described in (9), in the coil of motor described in (8), both edge portions of the thickness changed portion are deformed symmetrically so that respective thicknesses are reduced. Accordingly, it is possible to avoid a decrease in the sectional area of the edgewise bent portion more than the case where the entire thickness is reduced.

The stator of motor according to the in invention having such feature can provide operations and effects mentioned below.

The invention described in (10) is produced by using the coil of motor described in (8) or (9). This can enhance the space factor when the coil is mounted in the stator.

### BRIEF DESCRIPTION OF DRAWINGS

FIG. 1 is a perspective view of a coil in a first embodiment;

FIG. 2 is a cross-sectional view showing a state where the coil is placed in a slot of a stator core in the first embodiment;

FIG. 3 is a perspective view of a stator in which the coil is inserted in the stator core and coil ends are resin molded in the first embodiment;

FIG. 4 is a schematic view of a winding process for forming the coil in the first embodiment;

FIG. 5 is a side view of a bending mechanism included in a winding apparatus in the first embodiment;

FIG. 6 is a schematic view showing a configuration of a deforming mechanism included in the winding apparatus in the first embodiment;

FIG. 7 is a plan view schematically showing deformation caused when a rectangular conductor is edgewise bent in the first embodiment;

FIG. 8 is a schematic cross-sectional view of an edgewise bent portion, taken along a line B-B in FIG. 7;

FIG. 9 is a schematic view showing the bending mechanism to bend the rectangular conductor at 90° from a state in FIG. 4 in the first embodiment;

FIG. 10 is a schematic view showing the bending mechanism to return a fixing chuck to an original position from a state in FIG. 9 in the first embodiment;

FIG. 11 is a schematic view showing the bending mechanism to feed the rectangular conductor at a predetermined pitch from the state in FIG. 10 by a feeding chuck in the first embodiment;

FIG. 12 is a schematic view showing the bending mechanism to bend the rectangular conductor at 90° from a state in FIG. 11 in the first embodiment;

FIG. 13 is a schematic view showing the bending mechanism to further wind the rectangular conductor from a state in FIG. 12 in the first embodiment;

FIG. 14 is a side view of the bending mechanism of FIG. 13 in the first embodiment;

FIG. 15A is a schematic view showing a state of rolling and pressing a rectangular conductor by a deformation roller in a second embodiment;

FIG. 15B is a schematic view showing a state of feeding the rectangular conductor by the feeding chuck after rolling the rectangular conductor by the deformation roller in the second embodiment;

FIG. 16A is a schematic view showing a state of pressing a rectangular conductor by a press in a third embodiment;

FIG. 16B is a schematic view showing a state of feeding the rectangular conductor by the feeding chuck after pressing the rectangular conductor by the press in the third embodiment;

FIG. 17 is a perspective view of a coil in a fourth embodiment;

FIG. 18 is a cross-sectional view of an edgewise bent portion of the rectangular conductor in the fourth embodiment;

FIG. 19 is a side view of a bending mechanism in a fifth embodiment; and

FIG. 20 is a perspective view of a winding apparatus in Patent Literature 1.

### REFERENCE SIGNS LIST

10 Coil

15 Rectangular conductor

15a Thickness changed portions

15b Long side

15c Short side

16 Thickness increased portion

17 Thickness decreased portion

19 Bobbin

30 Stator core

31 Teeth part

32 Slot

33 Frame

41U, 41V, 41W Phase terminal

45 Resin molded portion

50 Stator

60 Winding apparatus

61 Feeding mechanism

62 Deforming mechanism

63 Annealing mechanism

65 Bending mechanism

70 Gear-shaped roller

71 Recessed-surface forming tooth

73 Deforming roller

75 Press

80 Feeding chuck

81 Rotary table

82 Fixing chuck

83 Shaft with guide

83a Guide portion

84 Scraper

84a Tapered portion

### DETAILED DESCRIPTION OF EMBODIMENTS

### First Embodiment

A detailed description of a first embodiment of the present invention will now be given referring to the accompanying drawings.

Firstly, the outline of a production process of a stator 50 in the first embodiment is briefly explained.

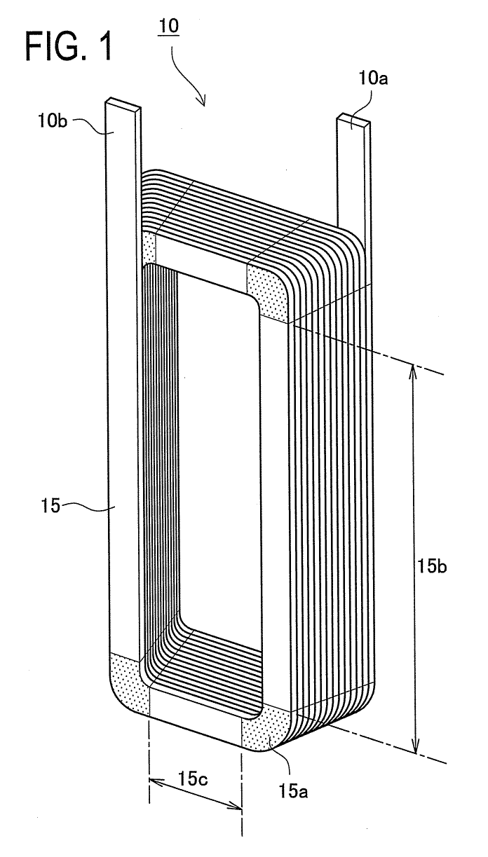

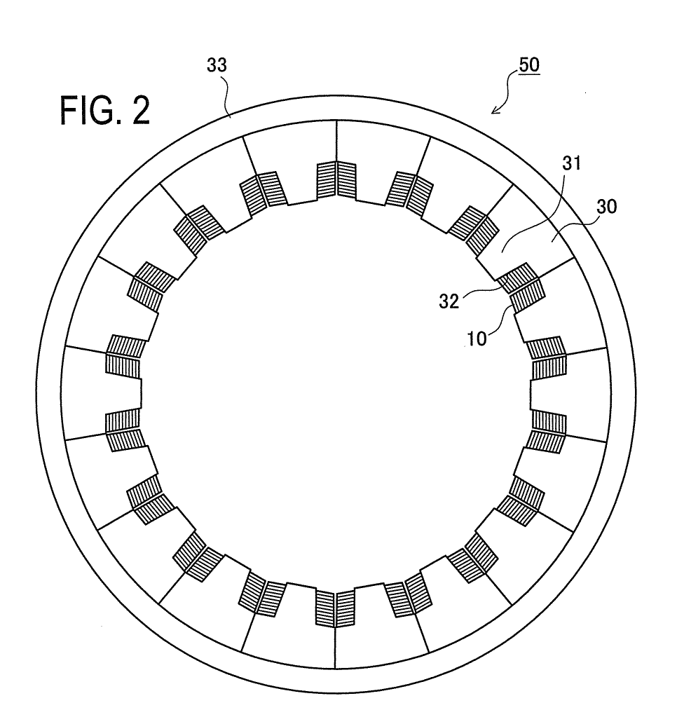

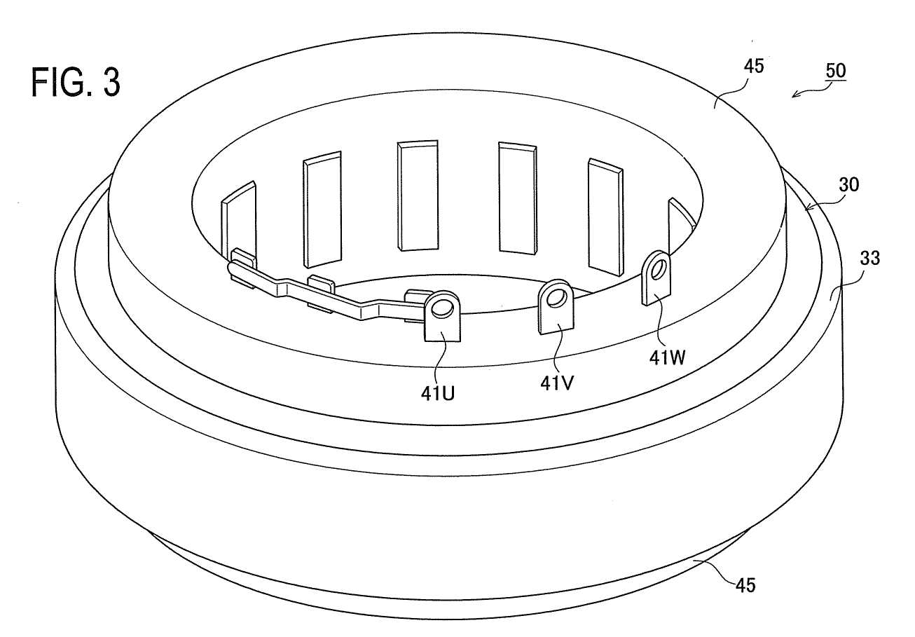

FIG. 1 is a perspective view of a coil 10 in a wound state in the first embodiment. FIG. 2 is a cross-sectional view of a stator core 30 with the coil 10 inserted therein. FIG. 3 shows a stator 50 whose coil ends are molded by resin.

The coil 10 is formed of a rectangular cross-section conductor (“rectangular conductor”) 15 that is spirally wound as shown in FIG. 1 to conform to the outer shape of a tooth 31 provided in the stator core 30. Thus, long sides 15b and short sides 15c are formed so that the short sides 15c are gradually longer from the inner periphery side to the outer periphery side of the stator core 30. The rectangular conductor 15 is made of a good conductive metal, such as copper, formed in a strip shape. The rectangular conductor 15 wound as the coil 10 is applied with an insulating coating, for example, a resin capable of ensuring insulation such as enamel, polyimide, and amideimide. Ends of the coil 10, i.e., an end portion 10a on an outer peripheral side and an end portion 10b on an inner peripheral side, include regions applied with no insulating coating.

Such coil 10 is placed in the stator core 30.

The stator core 30 is made of laminated steel plates and formed with the teeth 31 and slots 32 on the inner peripheral side as shown in FIG. 2. The stator core 30 in the first embodiment is constituted of split core parts and thus the stator core 30 is split at the center of each slot 32 between teeth 31. To form the stator core 30 in a cylindrical form, a frame 33 is placed to support the outer periphery of the stator core 30. The frame 33 may be any configuration but it is preferable to ensure rigidity as much as possible.

The coils 10 are placed in the stator core 30 which is then fixed in the cylindrical form by the frame 33. After that, the outer-peripheral-side end portions 10a and the inner-peripheral-side end portions 10b of the coils 10 are joined by link wires not shown to form a U phase, a V phase, and a W phase. A U phase terminal 41U, a V phase terminal 41V, a W phase terminal 41W, and others are thus joined. Resin-molded portions 45 are then formed as shown in FIG. 3. These resin-molded portions 45 serve to protect the coil ends and ensure insulation.

As above, the stator 50 is produced.

Next, a winding process of each coil 10 in the first embodiment is explained below.

### <Coil Winding Process>

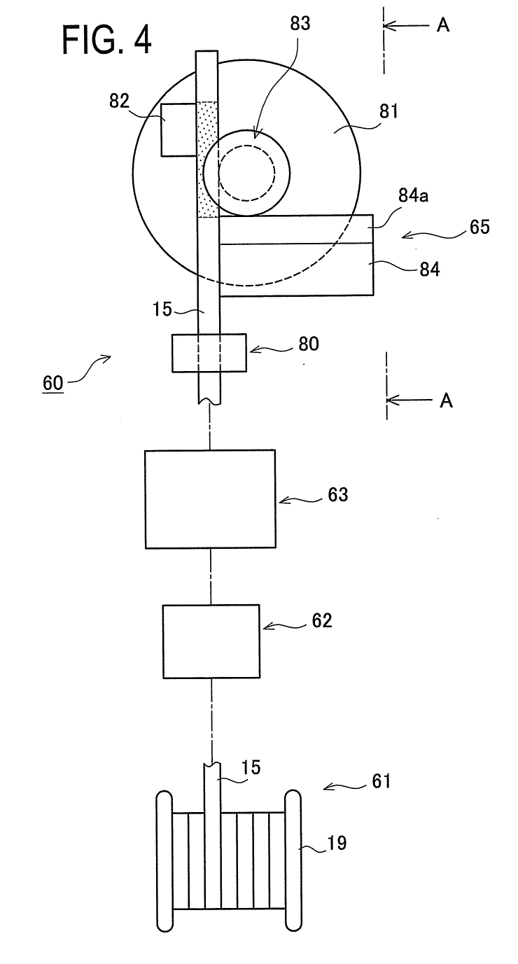

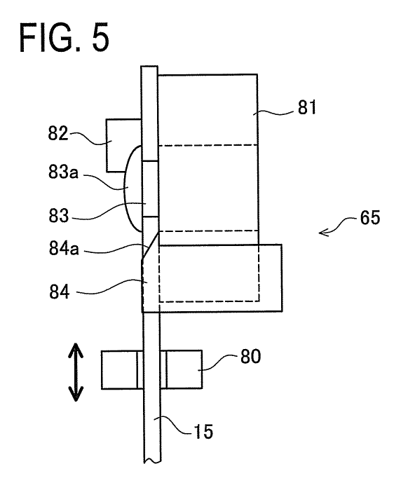

FIG. 4 is a schematic view of the winding process to produce the coil 10. FIG. 5 is a side view of a bending mechanism 65 taken along a line A-A in FIG. 4.

A winding apparatus 60 for producing the coil 10 includes four sections, i.e., a feeding mechanism 61, a deforming mechanism 62, an annealing section 63, and a bending mechanism 65.

In the feeding mechanism 61, a bobbin 19 on which the rectangular conductor 15 is wound is set to supply the rectangular conductor 15 to a subsequent step. In the feeding mechanism 61, a tensioner or the like is preferably provided to apply appropriate tension to the rectangular conductor 15 so that the rectangular conductor 15 is unreeled by a required length from the bobbin 19.

The deforming mechanism 62 includes a mechanism for pressing the rectangular conductor 15 to change the thickness thereof.

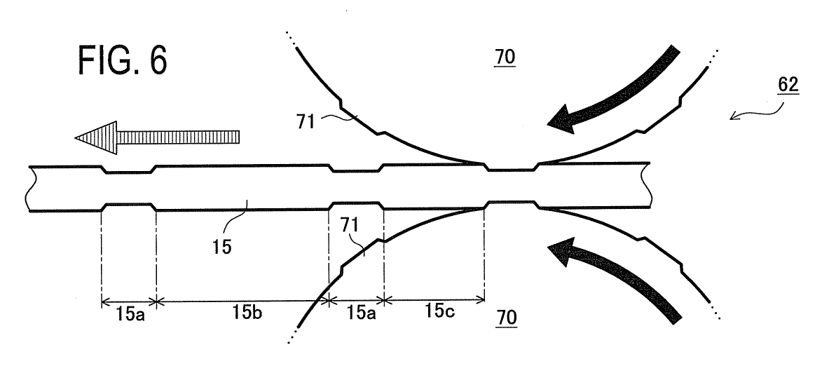

FIG. 6 is a schematic side view of a deforming mechanism using gear-shaped rollers 70 as one example of the deforming mechanism 62.

The gear-shaped rollers 70 are placed one above the other and will be rotated at the same time. Each roller 70 is formed with recessed-surface forming teeth 71 on the outer periphery. The teeth 71 serve to uniformly reduce the thickness of the rectangular conductor 15 in a direction of a short side of a rectangular cross-section thereof.

The rectangular conductor 15 is formed with thickness changed portions 15a at predetermined pitches. These pitches are determined by positions corresponding to bent portions at four corners of the coil 10 shown in FIG. 1.

Herein, an explanation is given to deformation that occurs during edgewise bending of the rectangular conductor 15.

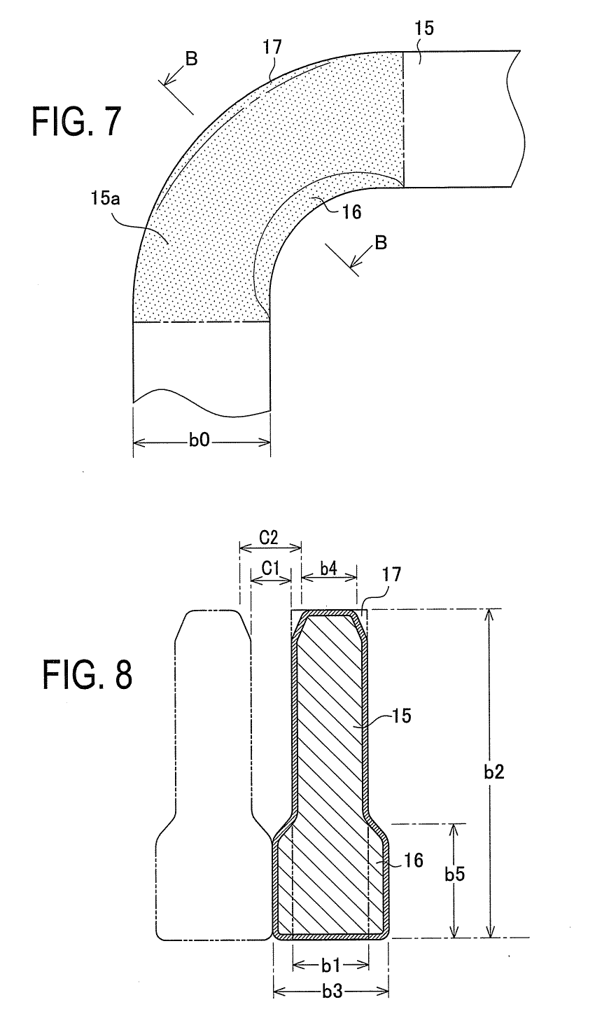

FIG. 7 is a schematic plan view showing the deformation caused when the rectangular conductor 15 is edgewise bent. FIG. 8 is a schematic cross-sectional view along a line B-B in FIG. 7.

When the rectangular conductor 15 is simply edgewise bent, a portion on the inner peripheral side is compressed while a portion on the outer peripheral side is stretched, resulting in a thickness increased portion 16 on the inner peripheral side of the coil 10 and a thickness decreased portion 17 on the outer peripheral of the coil 10. Assuming the original width of the rectangular conductor 15 to be a normal width b0 and the original thickness to be a normal thickness b1, when the edgewise bending is conducted, the thickness of the inner peripheral portion becomes an inner peripheral thickness b3 and the thickness of the outer peripheral portion becomes an outer peripheral thickness 4b as shown in FIG. 8. Furthermore, the width becomes an edgewise bent portion width b2.

The inner peripheral thickness b3 is thicker by about 12% than the normal thickness b1, forming the thickness increased portion 16. The inner peripheral thickness b4 is thinner by about 5% than the normal thickness b1, forming the thickness decreased portion 17. The edgewise bent portion width b2 tends to become narrower by about 9% than the normal width b0. A deformed portion height (width) b5 is lower than half of the width of the rectangular conductor 15. This deformed portion height b5 changes depending on an edgewise bending condition.

When the rectangular conductor 15 is edgewise bent, the thickness increased portion 16 and the thickness decreased portion 17 are generated in each edgewise bent portion of the rectangular conductor 15. In forming the coil 10, the rectangular conductor 15 is laminated with the inner peripheral thickness b3 due to each thickness increased portion 16. Thus, the adjacent portions having the normal thickness b1 are laminated with a central gap c1. Portions having the outer peripheral thickness b4 are laminated with an outer peripheral gap c2 which is larger than the central gap c1. This causes a problem that decreases the space factor.

Therefore, the thickness of the thickness changed portion 16a shown in FIG. 7 and FIG. 1 is reduced in advance over almost the entire area of each portion to be bent as above. Such thickness changed portion 15a is located at each of four corners of the coil 10 as shown in FIG. 1. The thickness changed portions 15a therefore need to be formed so that the long side 15b and the short side 15c of the coil 10 are alternately arranged between the thickness changed portions 15a.

The pitches of the recessed-surface forming teeth 71 of each gear-shaped roller 70 in the deforming mechanism 62 of FIG. 6 are determined to repeat the long side 15b and the short side 15c. Furthermore, each tooth 31 of the stator core 30 has a substantially trapezoidal shape as shown in FIG. 2 and hence the inner periphery of the coil 10 differs between the coil inner peripheral end portion 10a side and the coil outer peripheral end portion 10b side. Accordingly, the pitches of the recessed-surface forming teeth 71 of the gear-shaped roller 70 are determined so that the short sides 15c of the rectangular conductor 15 are gradually longer from the short side 15c formed close to the inner peripheral end portion 10b to that formed closer to the outer peripheral end portion 10a.

The outer peripheral length of each roller 70 needs to be equal or longer than the entire length of the coil 10 because the pitches between the teeth 71 are gradually changed as above.

The thickness of each thickness changed portion 15a formed in the rectangular conductor 15 tends to have the inner peripheral thickness b3 thicker by about 12% than the normal thickness b1. Accordingly, it is preferable to squeeze the rectangular conductor 15 to a thickness thinner by about 10% to 12% than the normal thickness b1 by the teeth 71.

The annealing section 63 shown in FIG. 4 is configured to allow the rectangular conductor 15 to pass through the inside thereof and may be provided simply with a heater for heating the rectangular conductor 15 or another method for heating. The rectangular conductor 15 is heated and annealed by passing through the annealing section 63. When passing through the deforming mechanism 62, the rectangular conductor 15 causes slight work hardening. It is therefore conceivable to soften the rectangular conductor 15 by heating after the process to anneal a work-hardened portion to prevent any influence during edgewise bending.

Such softening the rectangular conductor 15 by heating also provides an advantage that facilitates the edgewise bending.

The bending mechanism 65 includes a feeding chuck 80 for moving the rectangular conductor 15, a rotary table 81, a fixing chuck 82, a shaft with a guide portion (a “shaft”) 83, serving as a bending jig, and a scraper 84.

The feeding chuck 80 has a mechanism for taking the rectangular conductor 15 from the feeding mechanism 61 and feeding it at predetermined pitches. The rectangular conductor 15 forming the coil 10 needs to be wound with the long sides 15b and the short sides 15c being arranged alternately between the thickness changed portions 15a. Since the short sides 15c are gradually longer from the one close to the coil inner peripheral end portion 10b to the one close to the coil outer peripheral end portion 10a, the feeding chuck 80 is required to change a moving distance thereof to form each thickness changed portion 15a at an appropriate position.

Accordingly, the feeding chuck 80 is connected to a direct acting mechanism such as a servo mechanism to feed the rectangular conductor 15 by an arbitrary distance.

The rotary table 81 is a 90° turnable table and includes a rotary mechanism not shown capable of moving at predetermined angle. One surface of the rotary table 81 will come into contact with the rectangular conductor 15 and therefore a member having a surface of super steel or the like finished by buffing is provided in a portion of the table 81 on which the rectangular conductor 15 slides. On a surface which will contact with the rectangular conductor 15, the fixing chuck 82 capable of fixing the rectangular conductor 15 is placed.

The fixing chuck 82 is placed on a surface of the rotary table 81 on which the rectangular conductor 15 is allowed to slide. The fixing chuck 82 is moved on the table 81 to chuck or unchuck the rectangular conductor 15 and further hold the rectangular conductor 15. The surface which will hold the rectangular conductor 15 has been finished by surface treatment as buffing to prevent damages on the insulating coating of the rectangular conductor 15 and others.

The shaft 83 is placed to protrude from the surface of the rotary table 81 on which the rectangular conductor 15 will slide. An end of the shaft 83 is formed with a guide portion 83a that can contact with a side surface of the rectangular conductor 15 as shown in FIG. 5 to prevent tilting of the rectangular conductor 15. The surface of the shaft 83 that will contact with the rectangular conductor 15 also has been finished by surface treatment such as buffing.

The scraper 84 is a plate provided with a tapered portion 84a. A surface thereof on which the rectangular conductor 15 is allowed to slide has been finished by treatment such as buffing. The tapered portion 84a of the scraper 84 is formed so as to scoop up the rectangular conductor 15 to be wound spirally. During one turn of the rectangular conductor 15, the rectangular conductor 15 is scooped up by the tapered portion 84a and will not collide or interfere with another portion of the rectangular conductor 15 fed by the feeding chuck 80.

The first embodiment having the above configuration can provide the following operations and effects.

The process of winding the coil 10 by the winding apparatus 60 is first explained referring to the figures in order.

The rectangular conductor 15 wound around the bobbin 19 stored in the feeding mechanism 61 is fed by the feeding chuck 80 and the thickness changed portions 15a are formed by the recessed-surface forming teeth 71 of the gear-shaped rollers 70 in the deforming mechanism 62. Each thickness changed portion 15a is pressed to become thinner by about 10% to 12% than the normal thickness b1 by the teeth 71 so that the thickness changed portions 15a are located at four corners of the coil 10 as shown in FIG. 1.

The rectangular conductor 15 formed with the thickness changed portions 15a by the rollers 70 is heated in the annealing section 63. The rectangular conductor 15 formed with the thickness changed portions 16a has been work-hardened. Accordingly, it is annealed in the annealing section 63 to remove processing strain and thus the rectangular conductor 15 can be processed precisely during edgewise bending.

The annealing section 63 may be omitted according to the level of influence of work hardening.

The rectangular conductor 15 having passed the annealing section 63 is then edgewise bent in the bending mechanism 65.

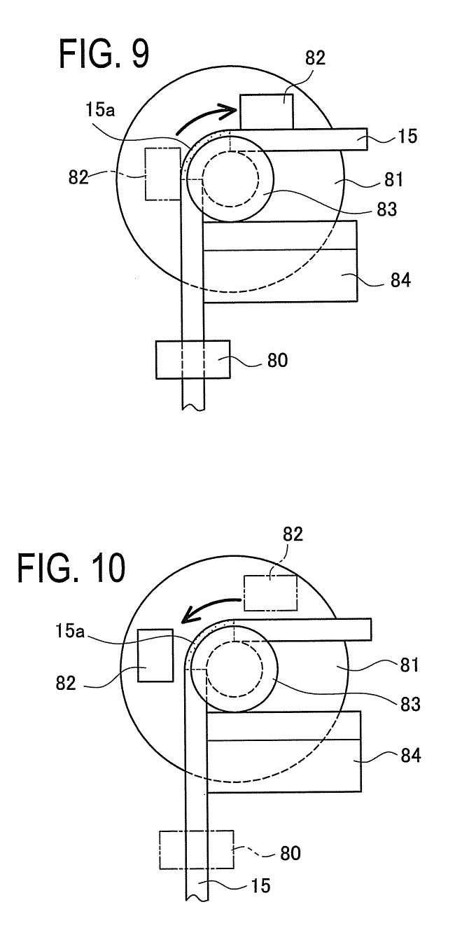

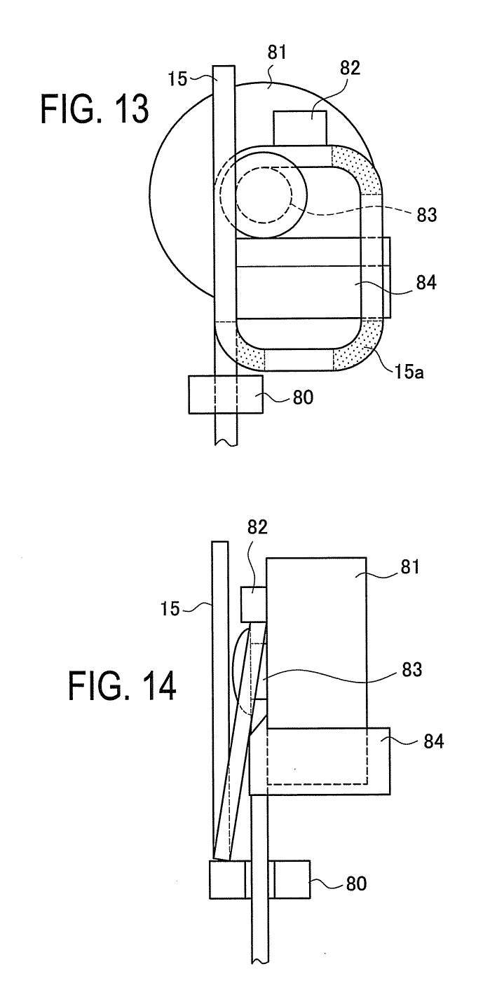

FIG. 9 is a schematic view showing a state where the rectangular conductor 15 is bent 90° from the state shown in FIG. 4. FIGS. 10 to 13 show the process of bending the rectangular conductor 15 in stages and FIG. 14 shows a side view of FIG. 13.

In the state in FIG. 4, the rectangular conductor 15 is chucked by the fixing chuck 82. Then, the rotary table 81 is rotated to edgewise bend the rectangular conductor 15 along the shaft 83 as shown in FIG. 9. During this edgewise bending, the guide portion 83a of the shaft 83 serves to prevent the rectangular conductor 15 from tilting. A portion edgewise bent in FIG. 9 is hereafter referred to as a first bent portion.

The thickness changed portion 16a of the rectangular conductor 15 exactly corresponds to a portion to be edgewise bent. This thickness changed portion 15a has been formed thinner by the deforming mechanism 62 and therefore the thickness thereof becomes equal to the normal thickness b1 when the thickness increased portion 16 is formed as shown in FIG. 7.

After the thickness changed portion 16a of the rectangular conductor 15 is edgewise bent, the fixing chuck 82 unchucks the rectangular conductor 15 and returns to an original position as shown in FIG. 10. For preventing movement of the rectangular conductor 15 during such operation, an additional chuck not shown may be provided. Specifically, in the state shown in FIG. 10, the additional chuck holds the rectangular conductor 15 against movement before the fixing chuck 82 unchucks the rectangular conductor 15, the fixing chuck 82 then unchucks the rectangular conductor 15 and returns to the predetermined position, and then the fixing chuck 82 chucks the rectangular conductor 15 again and the additional chuck unchucks the rectangular conductor 15. Thus, the rectangular conductor 15 is held against movement.

As the additional chuck mechanism for the fixing chuck 82, for example, there is a method in which the shaft 83 is configured to move in an axial direction to apply fixed pressure to the rectangular conductor 15. When the shaft 83 is operated to press the guide portion 83a against the first bent portion of the rectangular conductor 15, thereby fixing the position of the rectangular conductor 15.

As shown in FIG. 11, successively, the rectangular conductor 15 is fed by a predetermined pitch by the feeding chuck 80. The first bent portion of the rectangular conductor 15 is thus moved and a second portion to be bent is placed in contact with a side surface of the shaft 83. FIG. 11 shows a process of forming the short side 15c of the coil 10. Accordingly, the thickness changed portion 15 is located at a short interval and a feeding distance of the rectangular conductor 15 by the feeding chuck 80 is also short.

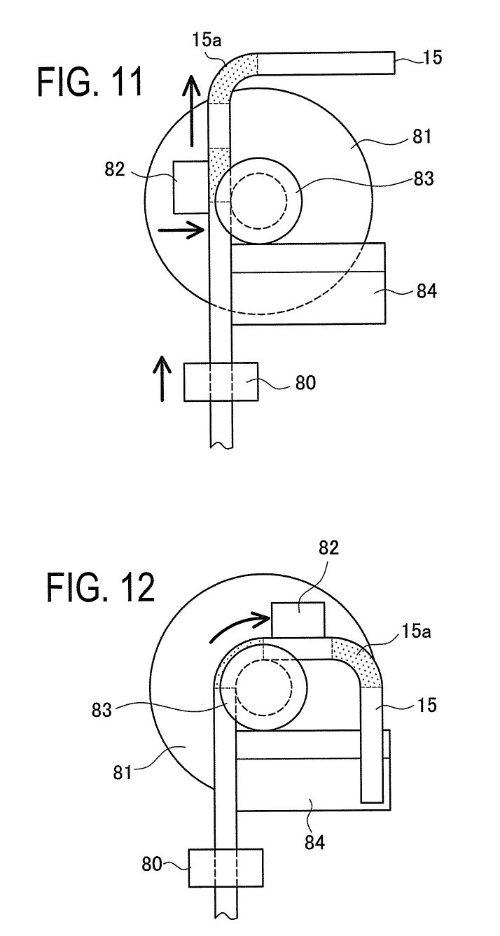

The rectangular conductor 15 fed at the predetermined pitch is chucked again by the fixing chuck 82 and is edgewise bent as shown in FIG. 12. The second bent portion is thus formed. At that time, the leading end of the rectangular conductor 15 runs onto the scraper 84.

The height of the scraper 84 is slightly higher than the thickness of the rectangular conductor 15. Accordingly, when the rectangular conductor 15 is further edgewise bent to form a third, fourth, and subsequent bent portions, a wound portion of the rectangular conductor 15 is laminated on another portion of the rectangular conductor 15 on a supply side of the bending mechanism 65 as shown in FIG. 13.

FIG. 14 is a side view of FIG. 13 and shows a state of laminating the rectangular conductor 15 without causing collision or interference with a portion of the rectangular conductor 15 just behind the feeding chuck 80 by operation of the scraper 84.

The scraper 84 shown in the figure simply has the tapered portion 84a in one surface. It is conceivable that while the rectangular conductor 15 is edgewise bent along the shaft 83, the leading end thereof is moved in a curve. Accordingly, the rectangular conductor 15 may be more smoothly wound by some configurations that a tapered portion 84a is provided in a position perpendicular to the illustrated tapered portion 84a, two tapered portions 84a are provided and chamfered to allow the rectangular conductor 15 to easily run thereon, or others.

When the coil 10 is wound as shown in FIG. 14, the gap between the portions of the rectangular conductor 15 is determined by the scraper 84. Depending on the positional relation thereof, the coil 10 is wound conceivably with gaps between the portions of the rectangular conductor 15. However, if the coil 10 is additionally compressed in the axial direction after winding by the bending mechanism 65, the coil 10 can be produced while the rectangular conductor 15 is laminated with no gap as shown in FIG. 1.

As above, according to the steps shown in FIGS. 9 to 14, the rectangular conductor 15 is wound as the coil 10.

Each of the four corners of the coil 10 is formed with the thickness changed portion 15a in which the thickness thereof has been thinned in advance and returned to the normal thickness b1 when the thickness increased portion 16 is formed after edgewise bending. The cross-section at that time is almost equal to that in FIG. 8, a portion corresponding to the inner peripheral thickness b3 comes to have the same thickness as the normal thickness b1. The edgewise bent portion width b2 is slightly increased when the thickness changed portion 16a is formed. Accordingly, the edgewise bent portion width b2 is a little wider than that in the case where the edgewise bending is conducted without forming the thickness changed portion 15a.

Even when the thickness increased portion 16 is generated as above, it becomes almost equal to the normal thickness b1. This prevents only an edgewise bent portion from bulging when the rectangular conductor 15 is wound and laminated as the coil 10, thereby avoiding formation of gaps between adjacent portions of the rectangular conductor 15 due to interference of bulges. This makes it possible to enhance the space factor of the coil 10 when mounted in the slot of the stator core 30.

Even when the thickness changed portion 15a is formed, the thickness decreased portion 17 is also generated in the rectangular conductor 15 that is edgewise bent. The inner peripheral thickness b4 is therefore further thinned. However, an electric current tends to flow in a place that enables the current to easily flow. Accordingly, an internal current density of the coil 10 rises and an external current density thereof lowers.

The applicant has confirmed that, even when the thickness decreased portion 17 is formed with the thin outer peripheral thickness b4, such thinned portion hardly changed a resistance value substantially and did not cause any influence. According to the experiments conducted by the applicant, it is found that any influence during use is not caused by the thinned portion if it is shorter than several tens % from the outer periphery.

In Patent Literature 1, as mentioned in the aforementioned Technical Problem section, some problems are found that when only one edge portion of the rectangular conductor is squeezed, the rectangular conductor is likely to warp in an opposite direction to edgewise bending, the rectangular conductor may be tilted during edgewise bending, and a difference in length between the long side and the short side of a rectangular core appears as a positional variation of the rectangular conductor and a portion of the rectangular conductor to be pressed by the load rollers is displaced.

In the first embodiment, however, the rectangular conductor 15 is fed by the feeding chuck 80, and the rectangular conductor 15 is edgewise bent while being pressed against the curved peripheral surface of the shaft 83. Accordingly, the rectangular conductor 15 does not swing to the right or left in FIG. 4. Consequently, even when the deforming mechanism 62 performs pressing and rolling, the thickness changed portion 15a can be rolled precisely. Thus, there is no need to increase the length of the thickness changed portion 16a more than needed.

As explained above, the coil production method exemplified in the first embodiment can provide the following configurations, operations, and effects.

(1) The coil production method for producing the motor coil 10 in a spirally wound form is achieved by edgewise bending the rectangular conductor 15 along the curved surface of the shaft 83 in a direction perpendicular to the short side of the rectangular cross-section while one surface of the rectangular conductor 15 having a rectangular cross-section is placed in contact with the shaft 83. In this method, the deforming mechanism 62 is used to form the thickness changed portion 15a corresponding to each of the four corners of the coil 10 constituted of the edgewise bent rectangular conductor 15, over the entire width of the rectangular conductor 15, so that the thickness corresponding to the length of the short side of the rectangular cross-section of the rectangular conductor 15 is reduced. The coil 10 is produced by forming the thickness changed portion 15a of the rectangular conductor 15 by the deforming mechanism 62 and edgewise bending the thickness changed portion 15a of the rectangular conductor 15.

Accordingly, the thickness changed portion 15a is reduced in thickness over the entire width of the rectangular conductor 15 instead of that only the inner peripheral side of the coil 10 of the rectangular conductor 15 is reduced in thickness before the edgewise bending as disclosed in Patent Literature 1. Thus, the material is uniformly spread forward and backward. The rectangular conductor therefore will not warp in a direction opposite to an edgewise bending direction, which may be caused when only the inner peripheral side of the coil 10 is reduced in thickness. This can produce the coil 10 capable of achieving a high space factor when inserted in the slot 32 of the stator core 30.

When the thickness changed portion is formed by reducing the normal thickness b1 over the entire width of the rectangular conductor 15 and then the thickness changed portion 15a is edgewise bent, the inner peripheral portion of the coil 10 bulges. A bulging amount caused by the edgewise bending is constant as long as the same bending is conducted. Accordingly, the thickness of the rectangular conductor 15 is reduced in advance so as to return to the original size by the bulging. Thus, the thickness of the rectangular conductor 15 returns to the original thickness after the edgewise bending. Consequently, unnecessary resistance portion is unlikely to be formed.

When the thickness of the rectangular conductor 15 is reduced over the entire width thereof, the thickness on the outer peripheral side remains thin after the edgewise bending. However, the current tends to flow in a place that allows the current to easily flow and, after the edgewise bending, the current density of the inner peripheral side is high and the current density of outer peripheral side is low. This hardly causes any influence.

When the thickness of the inner peripheral side of the edgewise bent rectangular conductor 15 is simply reduced, unnecessary warp in the opposite direction may occur. However, the thickness is reduced over the entire area and therefore the warp in the opposite direction is unlikely to occur.

Consequently, the coil production method capable of producing the motor coil 10 with an enhanced space factor of the rectangular conductor 15 with respect to the slot 32 of the stator core 30 can be provided.

(2) In the coil production method described in (1), the deforming mechanism 62 deforms the rectangular conductor 15 to reduce the normal thickness b1 by a thickness increasing amount of the normal thickness b1 of the inner peripheral side of the coil 10 estimated to increase when the rectangular conductor 15 is edgewise bent. Accordingly, after the rectangular conductor 15 is edgewise bent, the portion of the thickness changed portion 15a corresponding to the inner peripheral side of the coil 10 becomes equal to the original thickness of the rectangular conductor 15 not yet deformed by the deforming mechanism 62. Even when the rectangular conductor 15 is edgewise bent, therefore, the coil 10 can be produced with the thickness of the inner peripheral side being constant.

As mentioned above, the current density of the outer peripheral side of the coil 10 is low and hence it is not so influenced by the reduced thickness. Consequently, the coil production method can be provided to produce the coil 10 having a high space factor and provide substantially uniform resistance.

(3) In the coil production method described in (1) or (2), the deforming mechanism 62 is configured to press the thickness changed portion 15a from above and below by the gear-shaped rollers 70 symmetrically placed above and below the rectangular conductor 15, thereby reducing the thickness of the rectangular conductor 15. Thus, the thickness of the thickness changed portion 15a can be uniformly reduced.
(4) In the coil production method described in one of (1) to (3), including the rotary table 81 and the fixing chuck 82 which are rotated about the central axis of the curved surface of the shaft 83 to edgewise bend the rectangular conductor 15, and the feeding chuck 80 which feeds the rectangular conductor 15 at a predetermined distance relative to the shaft 83, thereby determining the edgewise bending position of the rectangular conductor 15. The bending mechanism 65 forms the thickness changed portion 15a of the rectangular conductor 15. The feeding chuck 80 moves the rectangular conductor 15 by the predetermined distance. When the rectangular conductor 15 is brought into contact with the curved surface of the shaft 83 by the rotary table 81 and the fixing chuck 82, the thickness changed portion 15a of the rectangular conductor 15 is edgewise bent. Accordingly, the steps of feeding the rectangular conductor 15 by the predetermined distance by the feeding chuck 80 and bending the rectangular conductor 15 by the rotary table 81 and the fixing chuck 82 are repeated to edgewise bend the rectangular conductor 15 to form the coil 10. Thus, the position to be bent by the shaft 83 and the position to be deformed by the rotary table 81 and the fixing chuck 82 will not be relatively moved, so that the rectangular conductor 15 can be deformed by a required amount at an intended position.
(5) The coil production method described in one of (1) to (4) includes the guide portion 83a for preventing the rectangular conductor 15 from tilting in the axial direction of the curved surface of the shaft 83 during edgewise bending. While the guide portion 83a presses against the long side of the rectangular cross-section of the rectangular conductor 15, the rectangular conductor 15 is edgewise bent. Accordingly, the rectangular conductor 15 can be guided and edgewise bent even if a force is exerted on the rectangular conductor 15 to tilt during edgewise bending.

The coil of motor shown in the first embodiment can provide the following configurations, operations, and effects.

(6) In the motor coil 10 formed in a spirally wound shape by edgewise bending the rectangular conductor 15 having a rectangular cross-section in the direction of the short side of the rectangular cross-section, the thickness changed portion 15a corresponding to each of the four corners of the coil 10 is formed over the entire width of the rectangular conductor 15 to reduce the thickness corresponding to the length of the short side of the rectangular cross-section of the rectangular conductor 15, and then the thickness changed portion 15a of the rectangular conductor 15 is edgewise bent. Thus, the thickness of the bent portion on the inner peripheral side is increased to become equal to the normal thickness b1 of another portion of the rectangular conductor 15. Accordingly, the coil 10 can be provided capable of enhancing the space factor when it is mounted in the slot 32 of the stator core 30.

The stator of motor shown in the first embodiment can provide the following configurations, operations, and effects.

(7) The stator 50 can be produced using the motor coil 10 described in (6), and therefore the space factor of the coil 10 when mounted in the stator 50 can be enhanced.

### Second Embodiment

Next, a second embodiment will be described below.

The second embodiment is substantially the same as the first embodiment excepting the configuration of the deforming mechanism 62. Thus, the deforming mechanism 62 is explained below.

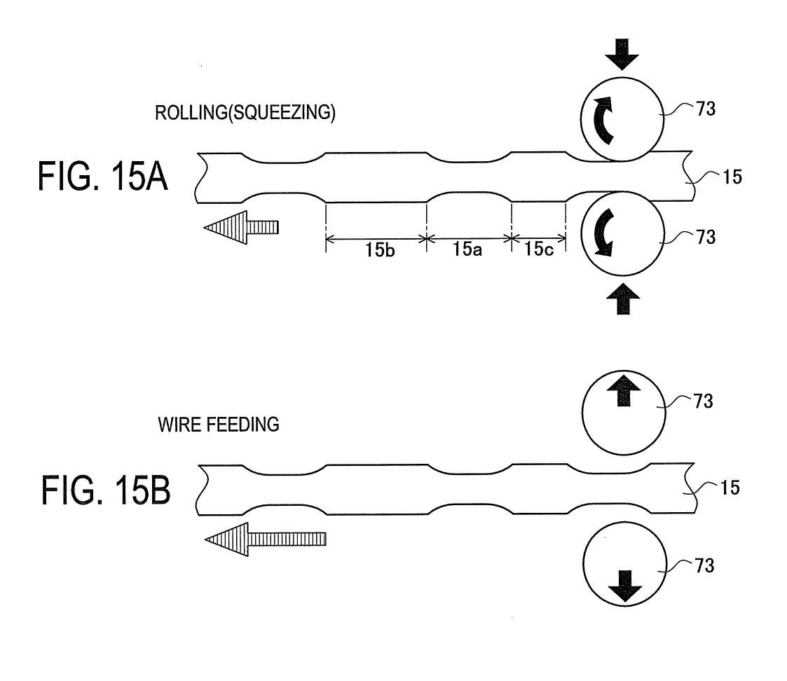

FIGS. 15A and 15B show the deforming mechanism 62 in the second embodiment; FIG. 15A shows that during rolling and FIG. 15B shows that during wire feeding.

Deforming rollers 73 are placed above and below the rectangular conductor 15 to form a thickness changed portion 15a in the rectangular conductor 15. As shown in FIG. 15A, during rolling, the deforming rollers 73 are rotated while pressing the rectangular conductor 15 from above and below.

After the thickness changed portion 15a is formed by the deforming rollers 73, as shown in FIG. 15B, the rollers 73 are retracted to allow the rectangular conductor 15 to be fed by a predetermined distance. The feeding mechanism can feed the rectangular conductor 15 to an arbitral position by the feeding chuck 80 as in the first embodiment.

The rectangular conductor 15 is thus formed with the thickness changed portions 15a between which the long side 15b and the short side 15c are alternately interposed. Accordingly, the feeding pitches are determined to make the long side 15b and the short side 15a alternately appear. Since the coil 10 is formed of the rectangular conductor 15 wound in a trapezoidal shape, the pitch of the short side 15c needs to be gradually longer. However, the feeding chuck 80 can be operated to feed the rectangular conductor 15 at the arbitrary distance and therefore the desired coil can be produced.

The second embodiment including the aforementioned deforming mechanism 62 can provide the following effects.

The deforming rollers 73 are placed above and below to form the thickness changed portions 15a one by one by pressing. Accordingly, such large gear-shaped rollers 70 as used in the first embodiment do not need to be provided. Thus, a facility can be downsized.

### Third Embodiment

Next, a third embodiment will be described below.

The third embodiment is substantially the same as the first embodiment excepting the configuration of the deforming mechanism 62. Thus, the deforming mechanism 62 is explained below.

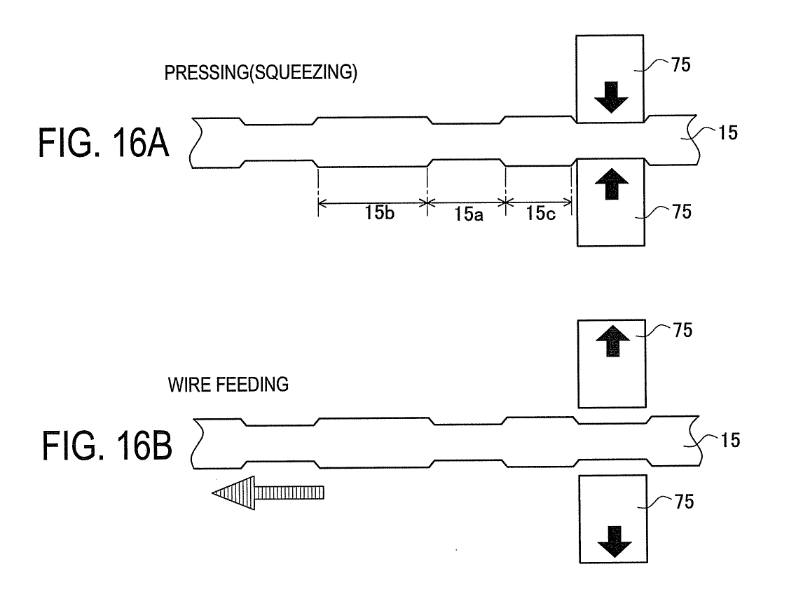

FIGS. 16A and 16B show the deforming mechanism 62 of the third embodiment; FIG. 16A shows that during press and FIG. 16B shows that during wire feeding.

Presses 75 are placed above and below the rectangular conductor 15 to form a thickness changed portion 15a in the rectangular conductor 15. As shown in FIG. 16A, during rolling, the presses 75 press the rectangular conductor 15 from above and below to form each thickness changed portion 15a.

After the thickness changed portion 15a is formed by the presses 75, as shown in FIG. 16B, the presses 75 are retracted to allow the rectangular conductor 15 to be fed by a predetermined distance. The feeding mechanism can feed the rectangular conductor 15 to an arbitral position by the feeding chuck 80 as in the first embodiment.

The rectangular conductor 15 is thus formed with the thickness changed portions 15a between which the long side 15b and the short side 15c are alternately interposed. Accordingly, the feeding pitches are determined to make the long side 15b and the short side 15a alternately appear. Since the coil 10 is produced of the rectangular conductor 15 wound in a trapezoidal shape, the pitch of the short side 15c needs to be gradually longer. However, the feeding chuck 80 can be operated to feed the rectangular conductor 15 at the arbitrary distance and therefore the desired rectangular conductor 15 can be produced.

The third embodiment including the aforementioned deforming mechanism 62 can provide the following effects.

The presses 75 are placed above and below to form the thickness changed portions 15a one by one by pressing. Accordingly, such large gear-shaped rollers 70 as used in the first embodiment do not need to be provided. Thus, a facility can be downsized.

Furthermore, when the rectangular conductor 15 is fed while being squeezed by the deforming rollers 73 as in the second embodiment, the rectangular conductor 15 has to be fed slowly to form a clear rolled surface of the thickness changed portion 15a. On the other hand, the presses 75 function to simply press the rectangular conductor 15 from above and below and therefore the mechanism is simple and a feeding speed can be increased.

### Fourth Embodiment

Next, a fourth embodiment will be described below.

The fourth embodiment is substantially the same as the first embodiment excepting a slight difference in the shape of the coil 10.

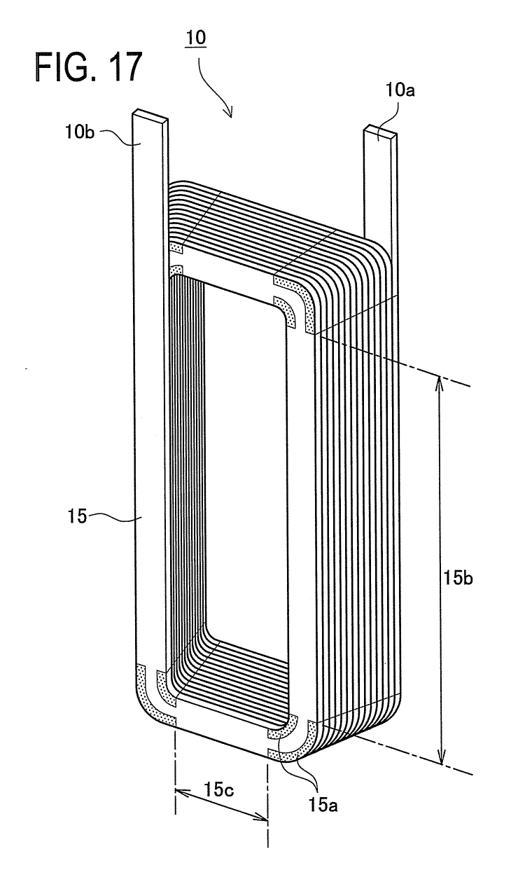

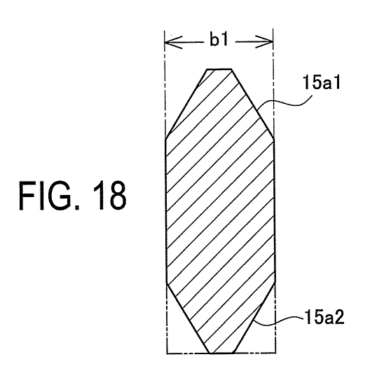

FIG. 17 is a stereographic perspective view of the coil 10 of the fourth embodiment. FIG. 18 is a cross-sectional view of an edgewise bent portion of the rectangular conductor 15, taken along a line B-B in FIG. 7.

The rectangular conductor 15 constituting the coil 10 of the fourth embodiment is formed with the changed portions 15a at only both edges of the rectangular conductor 15. For convenience, they are hereinafter referred to as an outer peripheral side thickness changed portion 15a1 and an inner peripheral side thickness changed portion 15a2. These thickness changed portions 15a1 and 15a2 are symmetric with respect to the center of the rectangular conductor 15 and formed by the deforming mechanism 62. They may be formed by any one of the gear-shaped rollers 70 of the first embodiment, the deforming rollers 73 of the second embodiment, and the presses 75 of the third embodiment.

When the thus formed thickness changed portions 15a1 and 15a2 of the rectangular conductor 15 are edgewise bent, only the inner peripheral side thickness portion 15a2 will bulge and return to the normal thickness b1.

The fourth embodiment having the aforementioned configuration can provide the following operations and effects.

Since the thickness changed portions 15a are formed on the inner peripheral side and the outer peripheral side of the rectangular conductor 15, a portion with reduced thickness is small than the rectangular conductor 15 having the thickness changed portion 15a over the entire width of the rectangular conductor 15.

Specifically, the outer peripheral side thickness changed portion 15a1 and the inner peripheral side thickness changed portion 15a2 are provided symmetrically with respect to the center of the rectangular conductor 15. Thus, the rectangular conductor 15 is uniformly pressed and no warp will be caused on an opposite side to edgewise bending as mentioned in the Technical Problem section related to Patent Literature 1.

The inner peripheral side thickness changed portion 15a2 can be balanced out and become almost equal to the normal thickness b1 when the thickness increased portion 16 is generated by edgewise bending. A region between the outer peripheral side thickness changed portion 15a1 and the inner peripheral side thickness changed portion 15a2 remains having the normal thickness b1. Therefore, a change rate of thickness is less than in the first and other embodiments.

Accordingly, in the edgewise bent portion, the portion that remains having the normal thickness b1 increases, which is unlikely to become resistance as compared with the first embodiment.

It is of course that the thickness increased portion 16 and the thickness decreased portion 17 of the rectangular conductor 15 will change even by a bending radius of the edgewise bent rectangular conductor 15 or the like. Thus, the squeezing techniques of the first embodiment and the fourth embodiment may be selected according to the deformed portion height b5. If this height b5 exceeds the center of the long side of the rectangular conductor 15, a method of forming the thickness changed portion 15a to narrow the thickness over the entire width of the rectangular conductor 15 as in the first embodiment may be selected. If the height b5 does not exceed the center of the long side of the rectangular conductor 15, a method of providing the inner peripheral side thickness changed portion 15a2 as in the fourth embodiment is preferably selected.

Since the inner peripheral side thickness changed portion 15a2 is provided as above, it will not become thicker than the normal thickness b1. This makes it possible to achieve a high space factor when the coil 10 is mounted in the slot 32 of the stator core 30.

Furthermore, the outer peripheral side thickness changed portion 15a1 is provided symmetric with the inner peripheral side thickness changed portion 15a2 and hence no warp will occur on the opposite side to the edgewise bending direction, and no winding disturbance will be caused.

The outer peripheral side thickness changed portion 15a1 is located on the outer peripheral side of the coil 10. Accordingly, even if it is thinner than the normal thickness b1, it is unlikely to become resistance during energization. As mentioned above, an electric current tends to flow in a path that allows the current to easily flow and thus the current density of the inner peripheral side of the coil 10 is high and the current density of the outer peripheral side is low. Consequently, even when the thickness of the coil 10 on the outer peripheral side is slightly thin, it will not substantially cause any influence during energization.

As explained above, the coil production method in the fourth embodiment can provide the following configurations, operations, and effects.

(1) The coil production method for producing the motor coil 10 in a spirally wound form is achieved by edgewise bending the rectangular conductor 15 along the curved surface of the shaft 83 in a direction perpendicular to the short side of the rectangular cross-section while one surface of the rectangular conductor 15 having a rectangular cross-section is placed in contact with the shaft 83. In this method, the deforming mechanism 62 is used to form the thickness changed portion 15a corresponding to each of the four corners of the coil 10 constituted of the edgewise bent rectangular conductor 15 so that the thickness corresponding to the length of the short side of the rectangular cross-section of the rectangular conductor 15 is reduced or to form the outer peripheral side thickness changed portion 15a1 and the inner peripheral side thickness changed portion 15a2 which are both edge portions of the thickness changed portion 15a so that their thicknesses are reduced. Deformation by the deforming mechanism 62 is symmetric with respect to the center line passing the center of the long side of the rectangular cross-section of the rectangular conductor 15. The coil 10 is produced by forming the outer peripheral side thickness changed portion 15a1 and the inner peripheral side thickness changed portion 15a2 of the rectangular conductor 15 by the deforming mechanism 62 and then edgewise bending the outer peripheral side thickness changed portion 15a1 and the inner peripheral side thickness changed portion 15a2 of the rectangular conductor 15.

Accordingly, instead of that only the inner peripheral side of the coil 10 of the rectangular conductor 15 is reduced in thickness before the edgewise bending as disclosed in Patent Literature 1, the outer peripheral side thickness changed portion 15a1 and the inner peripheral side thickness changed portion 15a2 which are both edge portions of the rectangular conductor 15 are reduced in thickness and symmetric. Thus, the material is uniformly spread forward and backward. The rectangular conductor therefore will not warp in the opposite direction to the edgewise bending direction, differently from the case where only the inner peripheral side of the coil 10 is reduced in thickness. This can produce the coil 10 capable of achieving a high space factor when inserted in the slot 32 of the stator core 30.

When the thickness changed portion is formed by reducing the normal thickness b1 of both edge portions of the rectangular conductor 15 and then the thickness changed portion 15a is edgewise bent, the inner peripheral side of the coil 10 will bulge. A bulging amount caused by the edgewise bending is constant as long as the same bending is conducted. Accordingly, when the thickness of the rectangular conductor 15 is reduced in advance so as to return to the original size when the rectangular conductor 15 bulges, the thickness of the rectangular conductor 15 returns to the original thickness after the edgewise bending. Consequently, unnecessary resistance portion is unlikely to be formed.

If the thickness of the rectangular conductor 15 is reduced also in the outer peripheral side thickness changed portion 15a1 in symmetric relation to the inner peripheral side thickness changed portion 15a2, the thickness of the coil 10 on the outer peripheral side remains thin after deformed bending. The electric current tends to flow in a place that allows the current to easily flow and, after the edgewise bending, the current density of the inner peripheral side is high and the current density of outer peripheral side is low. Thus, almost no influence is caused.

If the thickness of the edgewise bent rectangular conductor 15 on the inner peripheral side is only reduced as in Patent Literature 1, the rectangular conductor 15 may warp unnecessarily in the opposite direction. However, both edge portions of the rectangular conductor 15 are symmetrically reduced in thickness and hence the warp in the opposite direction will not occur.

Consequently, the coil production method capable of producing the motor coil 10 with an enhanced space factor of the rectangular conductor 15 with respect to the slot 32 of the stator core 30 can be provided.

(2) In the coil production method described in (1), the deforming mechanism 62 deforms the rectangular conductor 15 to reduce the normal thickness b1 by a thickness increasing amount of the normal thickness b1 on the inner peripheral side of the coil 10 estimated to increase when the rectangular conductor 15 is edgewise bent. Accordingly, after the rectangular conductor 15 is edgewise bent, the inner peripheral side thickness changed portion 15a2 becomes equal to the original thickness of the rectangular conductor 15 not yet deformed by the deforming mechanism 62. Even when the rectangular conductor 15 is edgewise bent, therefore, the coil 10 can be produced with the thickness of the inner peripheral side being constant.

As mentioned above, the current density of the outer peripheral side of the coil 10 is low and hence it is not so influenced by the reduced thickness. Consequently, the coil production method can be provided to produce the coil 10 having a high space factor and providing substantially uniform resistance.

The coil of motor shown in the fourth embodiment can provide the following configurations, operations, and effects.

(3) In the motor coil 10 produced in a spirally wound form by edgewise bending the rectangular conductor 15 having a rectangular cross-section, in the short side direction, both edge portions of the thickness changed portion 15a corresponding to four corners of the coil 10 are symmetrically formed by reducing their thickness, the thickness changed portion 15a of the rectangular conductor 15 is edgewise bent, so that the thickness of the bent portion on the inner peripheral side is increased to become equal to another portion of the rectangular conductor 15. This makes it possible to more reduce the cross-sectional area of the edgewise bent portion as compared with the case where the thickness is reduced over the entire width, thereby contributing enhancement of the space factor of the coil 10 when mounted in the slot 32 of the stator core 30.

Furthermore, the stator of motor in the fourth embodiment can provide the following configurations, operations, and effects.

(4) The stator is produced using the coil of motor described in (3). Accordingly, the space factor of the coil 10 when mounted in the stator 50 can be enhanced.

### Fifth Embodiment

Next, a fifth embodiment will be described below.

The fifth embodiment is substantially the same as the first embodiment excepting the configuration of the shaft 83 provided in the bending mechanism 65. Furthermore, the deforming mechanism 62 and the annealing section 63 are not provided.

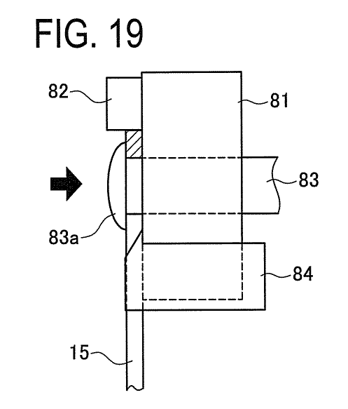

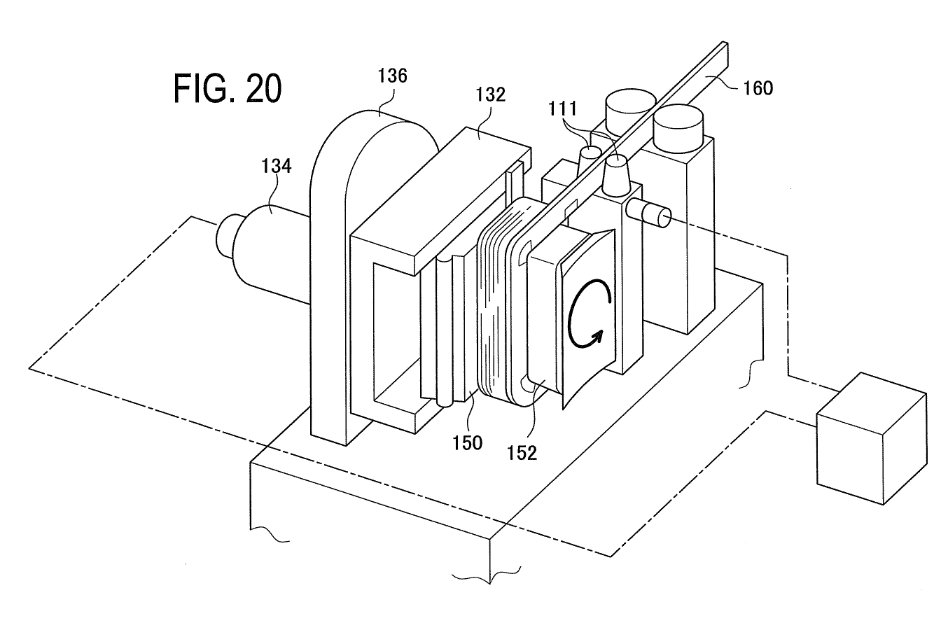

FIG. 19 is a side view of the bending mechanism 65 of the fifth embodiment.

The shaft 83 of the fifth embodiment is configured to press the rectangular conductor 15 in a direction of a rotation axis of the rotary table 81. The guide portion 83a of the shaft 83 is movable relative to the sliding surface of the rotary table 81 on which the rectangular conductor 15 can slide until the guide portion 83a comes to a position at the same distance as the normal thickness b1 of the short side of the rectangular conductor 15. The guide portion 83a is moved to press the rectangular conductor 15 after edgewise bending of the rectangular conductor 15.

The fifth embodiment does not include the deforming mechanism 62 and the annealing section 63 shown in FIG. 4 and uses the winding apparatus 60 including two mechanisms, i.e., the feeding mechanism 61 and the bending mechanism 65, to process the rectangular conductor 15.

The rectangular conductor 15 is unreeled from the bobbin 19 set in the feeding mechanism 61 and is fed at a predetermined pitch by the feeding chuck 80. In the bending mechanism 65, the rectangular conductor 15 is chucked by the fixing chuck 82 and then the rotary table 81 is rotated to edgewise bend the rectangular conductor 15 along the shaft 83.

In the fifth embodiment, different from the first embodiment, the thickness changed portion 15a is not provided in advance. After edgewise bending of the rectangular conductor 15, the guide portion 83a of the shaft 83 presses the portion corresponding to the thickness changed portion 15a to reduce the thickness of the short side of the rectangular conductor 15, thereby squeezing the rectangular conductor 15 to change the thickness of the thickness increased portion 16 from the inner peripheral thickness b3 to the normal thickness b1 in FIG. 8.

Since the thickness of the coil 10 becomes constant to be the normal thickness b1, the space factor of the coil 10 when mounted in the slot 32 of the stator core 30 can be enhanced.

The rectangular conductor 15 is edgewise bent and then pressed in the thickness increased portion 16. Accordingly, the rectangular conductor 15 does not need to be squeezed more than necessary and can be made similar to an original cross-sectional shape of the rectangular conductor 15 not yet edgewise bent.

This can further reduce factors tending to cause resistance during energization after the coil 10 is mounted in the stator core 30.

The deforming mechanism 62 and the annealing section 63 shown in FIG. 4 of the first embodiment are unnecessary, which contributes to downsizing of a facility. Furthermore, the facility can be shortened by the installation space corresponding to the deforming mechanism 62 and the annealing section 63. Thus, waste of the rectangular conductor 15 can be reduced.

Because the rectangular conductor 15 is supplied from the bobbin 19, the feeding mechanism 61 inevitably needs replacement of the bobbin 19 after use of a predetermined length of the rectangular conductor 15. Depending on the facility configuration, portions of the rectangular conductor 15 just before and just after replacement of the bobbin 19 cannot be processed and thus cannot not be used as a material of the coil 10.

However, when the winding apparatus 60 itself is shortened, such waste material can be reduced.

The coil production method in the fifth embodiment as explained above can provide the following configurations, operations, and effects.

(1) The coil production method for producing the motor coil 10 in a spirally wound form is achieved by edgewise bending the rectangular conductor 15 along the curved surface of the shaft 83 in a direction perpendicular to [[of]] the short side of the rectangular cross-section while one surface of the rectangular conductor 15 having a rectangular cross-section is placed in contact with the shaft 83. In this method, the shaft 83 is provided with the guide portion 83a on one side of the curved surface for preventing the rectangular conductor 15 from tilting in the axial direction of the curved surface of the shaft 83 during edgewise bending. The rectangular conductor 15 is edgewise bent by the rotary table 81 and the fixing chuck 82 and then is pressed by the shaft 83 in the axial direction thereof. Accordingly, the guide portion 83a presses the rectangular conductor 15 to form the thickness changed portion 16a corresponding to each of the four corners of the coil 10 constituted of the edgewise bent rectangular conductor 15 so that the thickness corresponding to the length of the short side of the rectangular cross-section of the rectangular conductor 15 is reduced. This corrects the bulging of the rectangular conductor 15 caused by the edgewise bending. The deforming mechanism 62 does not need to be provided additionally and hence the facility can be simplified.

The present invention is explained referring to the first to fifth embodiments but not limited to the first to fifth embodiment. The present invention may be embodied in other specific forms without departing from the essential characteristics thereof.

For instance, the configuration of the bending mechanism 65 is exemplified as the configurations of the rotary table 81 and the fixing chuck 82. As an alternative, the rotary table 82 and the fixing chuck 82 may be integrally provided. Even in the surface treatment such as buffing, chrome plating such as hard chrome plating may be used or coating such as ceramic coating may be used to enhance slidability of the rectangular conductor 15.

In the first to fifth embodiments, the rectangular conductor 15 is deformed from both surfaces thereof, that is, both ends of the short side of the rectangular cross-section. Instead, it may be deformed from either one surface. In the case where only the inner peripheral side of the coil 10 is deformed as described in Patent Literature 1, movement of the material is likely to become unbalanced, causing the rectangular conductor 15 to warp on the outer peripheral side of the coil 10, i.e., on the opposite side to the edgewise bending direction. In the case where the thickness of the short side is reduced uniformly on the inner peripheral side and the outer peripheral side or entirely from one side, such defect will not occur.

1. A coil production method for forming a coil of motor in a spirally wound form by edgewise bending a rectangular conductor having a rectangular cross-section along a curved surface of a bending jig in a direction of a short side of the rectangular cross-section while one surface of the rectangular conductor is placed in contact with a bending jig, wherein
the method comprises:
deforming the rectangular conductor uniformly over the entire width thereof with a deforming mechanism so that the thickness corresponding to a length of the short side of the rectangular cross-section of the rectangular conductor is reduced to form a thickness changed portion corresponding to each of four corners of the coil constituted of the edgewise bent rectangular conductor, and wherein
the method further comprises:
forming the thickness changed portion of the rectangular conductor with the deforming mechanism; and
edgewise bending the thickness changed portion of the rectangular conductor to form the coil.

2. A coil production method comprising:
forming a coil of a motor in a spirally wound form by edgewise bending a rectangular conductor having a rectangular cross-section along a curved surface of a bending jig in a direction of a short side of the rectangular cross-section while one surface of the rectangular conductor is placed in contact with a bending jig, wherein
the method further comprises:
deforming the rectangular conductor over the entire width thereof with a deforming mechanism so that the thickness corresponding to a length of the short side of the rectangular cross-section of the rectangular conductor is reduced to form a thickness changed portion corresponding to each of four corners of the coil constituted of the edgewise bent rectangular conductor, and wherein
the method further comprises:
reducing the thickness so that both edge portions of the thickness changed portion are symmetric with respect to a center line passing the center of a long side of the rectangular cross-section of the rectangular conductor; and
edgewise bending the thickness changed portion of the rectangular conductor to form the coil.

3. The coil production method described in claim 1, wherein the method further comprises:
deforming the rectangular conductor with a deforming mechanism to reduce the thickness by a thickness increasing amount of the thickness on an inner peripheral side of the coil estimated to increase when the rectangular conductor is edgewise bent, so that after edgewise bending of the rectangular conductor, a portion of the thickness changed portion on the inner peripheral side of the coil becomes equal to the original thickness of the rectangular conductor not yet deformed by the deforming mechanism.

4. The coil production method described in claim 1, wherein the method further comprises:
pressing the thickness changed portion by sandwiching the rectangular conductor from above and below with a press symmetrically placed above and below the rectangular conductor to reduce the thickness of the rectangular conductor.

5. The coil production method described in claim 1, wherein the method further comprises:
edgewise bending the rectangular conductor with a bending mechanism that is rotatable about a central axis of a curved surface of the bending jig; and
feeding the rectangular conductor at a predetermined distance relative to the bending jig to determine a position of the rectangular conductor to be edgewise bent, wherein
the method further comprises:
forming the thickness changed portion of the rectangular conductor by the deforming mechanism;
feeding the rectangular conductor at the predetermined distance by the feeding mechanism, and
edgewise bending the thickness changed portion of the rectangular conductor while placing the rectangular conductor in contact with the curved surface of the bending jig by the bending mechanism.

6. The coil production method described in claim 1, wherein
the method further comprises:
preventing, with a tilt-preventing device, the rectangular conductor from tilting in an axial direction of the curved surface of the bending jig during edgewise bending, and
edgewise bending the rectangular conductor while pressing the long side of the rectangular cross-section of the rectangular conductor with the tilt-preventing device.

7. The coil production method described in claim 6, wherein
the tilt-preventing device is provided on one side of the curved surface of the bending jig,
the bending jig includes a mechanism for pressing in the axial direction to be also used as the deforming mechanism,
the method further comprising:
edgewise bending the rectangular conductor with the bending mechanism and then pressing the thickness changed portion of the rectangular conductor with the tilt-preventing device to correct a bulging portion of the rectangular conductor generated during the edgewise bending.

8. A coil of a motor formed in a spirally wound shape by edgewise bending the rectangular conductor having a rectangular cross-section in a direction of a short side of a rectangular cross-section of the rectangular conductor,
wherein the rectangular conductor is deformed over the entire width thereof so that the thickness corresponding to a length of the short side of the rectangular cross-section is reduced to form a thickness changed portion corresponding to each of four corners of the coil, and
the thickness changed portion of the rectangular conductor is edgewise bent and the thickness of a bent portion on the inner peripheral side is increased to become equal to the thickness of another portion of the rectangular conductor.

9. The coil of the motor described in claim 8, wherein
both edge portions of the thickness changed portion are deformed symmetrically so that respective thicknesses are reduced.

10. A stator of a motor produced using the coil of a motor described in claim 8.

11. The coil production method described in claim 2, wherein the method further comprises:
deforming the rectangular conductor with a deforming mechanism to reduce the thickness by a thickness increasing amount of the thickness on an inner peripheral side of the coil estimated to increase when the rectangular conductor is edgewise bent, so that after edgewise bending of the rectangular conductor, a portion of the thickness changed portion on the inner peripheral side of the coil becomes equal to the original thickness of the rectangular conductor not yet deformed by the deforming mechanism.

12. The coil production method described in claim 2, wherein the method further comprises:
pressing the thickness changed portion by sandwiching the rectangular conductor from above and below with a press symmetrically placed above and below the rectangular conductor to reduce the thickness of the rectangular conductor.

13. The coil production method described in claim 2, wherein the method further comprises:
edgewise bending the rectangular conductor with a bending mechanism that is rotatable about a central axis of a curved surface of the bending jig; and
feeding the rectangular conductor at a predetermined distance relative to the bending jig to determine a position of the rectangular conductor to be edgewise bent, wherein
the method further comprises:
forming the thickness changed portion of the rectangular conductor by the deforming mechanism;
feeding the rectangular conductor at the predetermined distance by the feeding mechanism, and
edgewise bending the thickness changed portion of the rectangular conductor while placing the rectangular conductor in contact with the curved surface of the bending jig by the bending mechanism.

14. The coil production method described in claim 2, wherein
the method further comprises:
preventing, with a tilt-preventing device, the rectangular conductor from tilting in an axial direction of the curved surface of the bending jig during edgewise bending, and
edgewise bending the rectangular conductor while pressing the long side of the rectangular cross-section of the rectangular conductor with the tilt-preventing device.

15. A stator of a motor produced using the coil of a motor described in claim 9.
